(19) United States
(12) Patent Application Publication
(10) Pub. No.: US 2008/0295979 A1
(43) Pub. Date: Dec. 4, 2008

(54) INDEPENDENTLY OPERABLE SECURE VENTILATING GARAGE DOOR

(76) Inventor: Rodney D. Carlsen, Hesperia, CA (US)

Correspondence Address: PATENT VENTURE GROUP, 10788 CIVIC CENTER DRIVE, SUITE 215, RANCHO CUCAMONGA, CA, 91730, US

(21) Appl. No.: 12/105,490

(22) Filed: Apr. 18, 2008

(51) Int. Cl. E05D 15/06; E06B 9/00; E04C 2/42

(52) U.S. Cl. 160/197; 49/332; 52/673

(57) ABSTRACT

An invention is provided for an independently operable ventilating security garage door system. The invention includes a ventilating security garage door that is permeable to light and air, and is wider than the existing garage door. The system also includes a plurality of ventilating security garage door rails that allow the ventilating security garage door to move between open and closed positions. Each rail is disposed to an outside of an existing garage door rail. Connected to the ventilating security garage door via cables is a rear torsion assembly, which is disposed behind the ventilating security garage door. In operation, the rear torsion assembly provides torque to assist in opening and closing the ventilating security garage door.

### BACKGROUND OF THE INVENTION

1. Field of the Invention

This invention relates generally to garage doors and screens, and more particularly to an independently operable secure ventilating garage door.

2. Description of the Related Art

Individuals today often use their garage work, hobby, and leisure space in addition to parking vehicles and extra storage. However, because of heat buildup and lighting issues, users often open their garage doors to allow light and fresh air to enter the garage, thus enhancing their activities within their garage. Although, an open garage door allows light to enter the garage and air to circulate with cooler, outside air, an open garage door can present a security risk to property located within the garage. Because the garage often is left unattended when open, stored material located within the space of the open garage is at risk to unscrupulous parties in the vicinity of the open garage.

In addition to risks to property stored in the garage, security risks also are encountered when, for example, the interior of the garage is attached to an interior entry to the house. As it is common for individuals to leave doors leading to the garage open when working or otherwise using the garage, intruders entering the garage have easy access to the interior of the home when the garage door is open. In addition to the above security issues, individuals often allow pets to roam free in there garages. However, when the garage door is open, access is granted to the outside environment. As a result, pets may wander outside the garage and subsequently get lost, stolen or otherwise injured.

To address some of these issues, prior art garage screen doors have been developed. The prior art garage screen doors have attempted to allow a user to utilize their garage when the garage door is open, while simultaneously allowing light and fresh air to enter the garage area in a secure or semi-secure manner. Unfortunately, prior art garage screen doors generally do not easily operate independently of the garage door and are difficult to put in place and remove once in place. For example, a typical prior art garage screen door opens or closes with the garage door. That is, prior garage screen doors generally include a mechanism that attaches the garage screen door to the garage door such that when the garage door moves, the garage door pulls the garage screen door along with it.

Thus, to open a prior art garage screen door, the user generally must first attach the garage screen door to the garage door using the above described attachment mechanism. Then, the user opens the garage door, for example, using a garage door opener. As the garage door opens, the garage door pulls the attached garage screen door along with it, opening both the garage door and the garage screen door. Conversely, to close the garage screen door, the user closes the garage door, which again pulls the attached garage screen door along with it into the closed position. The user then is required to detach the garage screen door from the garage door. Once detached, the garage door then is reopened, leaving the prior art garage screen door in place.

Unfortunately, in addition to being difficult to operate (i.e., open and close), prior art garage screen doors often do not with existing garage doors. Specifically, prior art garage screen doors generally require a completely new installation of both the existing garage door and the prior art garage screen door because prior art garage screen doors generally cannot operate within the existing radius and position of existing garage door tracks. That is, prior art garage screen door designs cause the garage screen door to “run into” or otherwise entangle itself with the existing garage door when opening or closing the garage door and the garage screen door in tandem.

In view of the foregoing, there is a need for an apparatus that is independently operable and provides secure ventilation when the garage door is open. For example, the apparatus should operate independently of the garage door, thus not requiring tandem operation. In addition, the apparatus should be capable of being easily added to existing garage doors, and not requiring a new installation of the existing garage door.

### SUMMARY OF THE INVENTION

Broadly speaking, the present invention addresses these needs by providing an independently operable secure ventilating garage door. For example, in one embodiment, a ventilating security garage door system is disclosed. The ventilating security garage door system includes a ventilating security garage door that is permeable to light and air, and is wider than the existing garage door. The system also includes a plurality of ventilating security garage door rails that allow the ventilating security garage door to move between open and closed positions. Each ventilating security garage door rail is disposed to an outside of an existing garage door rail. Connected to the ventilating security garage door via cables is a rear torsion assembly, which is disposed behind the ventilating security garage door. In operation, the rear torsion assembly provides torque to assist in opening and closing the ventilating security garage door.

To provide greater flexibility, a further embodiment includes a mechanism for independently and automatically opening and closing the door. This embodiment includes a ventilating security garage door permeable to light and air as above. Here, the ventilating security garage door is wider and shorter than the existing garage door. Similar to above, a plurality of ventilating security garage door rails is included to allow the ventilating security garage door to move to open and closed positions. To facilitate cable placement, each ventilating security garage door rail is disposed at least 2 inches to an outside of an existing garage door rail. A rear torsion assembly is disposed behind the ventilating security garage door and is connected to the ventilating security garage door via cables. The rear torsion assembly includes a rear torsion assembly bar connected to at least one torsion spring, thus providing torque to assist in opening and closing the ventilating security garage door. The ventilating security garage door system further includes a jackshaft garage door opener connected to the rear torsion assembly bar. In this embodiment, the jack shaft garage door opener provides rotational torque to the rear torsion assembly bar to open and close the ventilating security garage door. A plurality of pulleys, each positioned to either side and above of the ventilating security garage door can be included that allows the cables to extend from the rear torsion assembly to the ventilating security garage door via the pulleys. Since the garage door rails are positioned outside the existing garage door rails, the cables can extend between the ventilating security garage door rails and the existing garage door rails, without interfering with the operation of the existing garage door.

For added security, a security lock system can be included that is capable of locking the ventilating security garage door when the ventilating security garage door is in a closed position. Here, the security lock system can disengage when the jackshaft garage door opener receives a signal to open or close the ventilating security garage door. In general, the security lock system is disposed to one side of the ventilating security garage door, and is positioned nearer to a bottom edge of the ventilating security garage door than to a top edge of the ventilating security garage door.

In this manner, embodiments of the present invention advantageously can be utilized with an existing garage door installation, thus not requiring the original garage door to be uninstalled and reinstalled to operate with the embodiments of the present invention. This is accomplished via an inventive rail system and rear torsion placement that allows embodiments of the present invention to operate without interfering with normal garage door operation. For example, by placing the torsion for the ventilating security garage door system to the rear of the unit, the rear torsion assembly of the embodiments of the present invention advantageously does not interfere with the existing garage door operating units, such as the chain based garage door opener. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram showing an exemplary ventilating security garage door system for use with an existing garage door, in accordance with an embodiment of the present invention;

FIG. 2 is a side view of exemplary ventilating security garage door rails and rear torsion assembly, in accordance with an embodiment of the present invention;

FIG. 3 is a diagram showing a review of the relative rail positions for use with the ventilating security garage door, in accordance with an embodiment of the present invention; and

FIG. 4 is a diagram showing an exemplary ventilating security garage door system having automatic operating properties and locking properties, in accordance with an embodiment of the present invention.

### DETAILED DESCRIPTION OF THE PREFERRED EMBODIMENTS

An invention is disclosed for an independently operable secure ventilating garage door. Broadly speaking, embodiments of the present invention provide a secure ventilating garage door that can be independently operated, for example, via an opener independent from the main garage door opener. As will be described in greater detail subsequently, embodiments of the present invention advantageously can be utilized with an existing garage door installation, thus not requiring the original garage door to be uninstalled and reinstalled to operate with the embodiments of the present invention. This is accomplished via an inventive rail system and rear torsion placement that allows embodiments of the present invention to operate without interfering with normal garage door operation. Moreover, embodiments of the present invention provide additional security via a locking mechanism that engages when the ventilating security garage door of the embodiments of the present invention is in a closed position.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

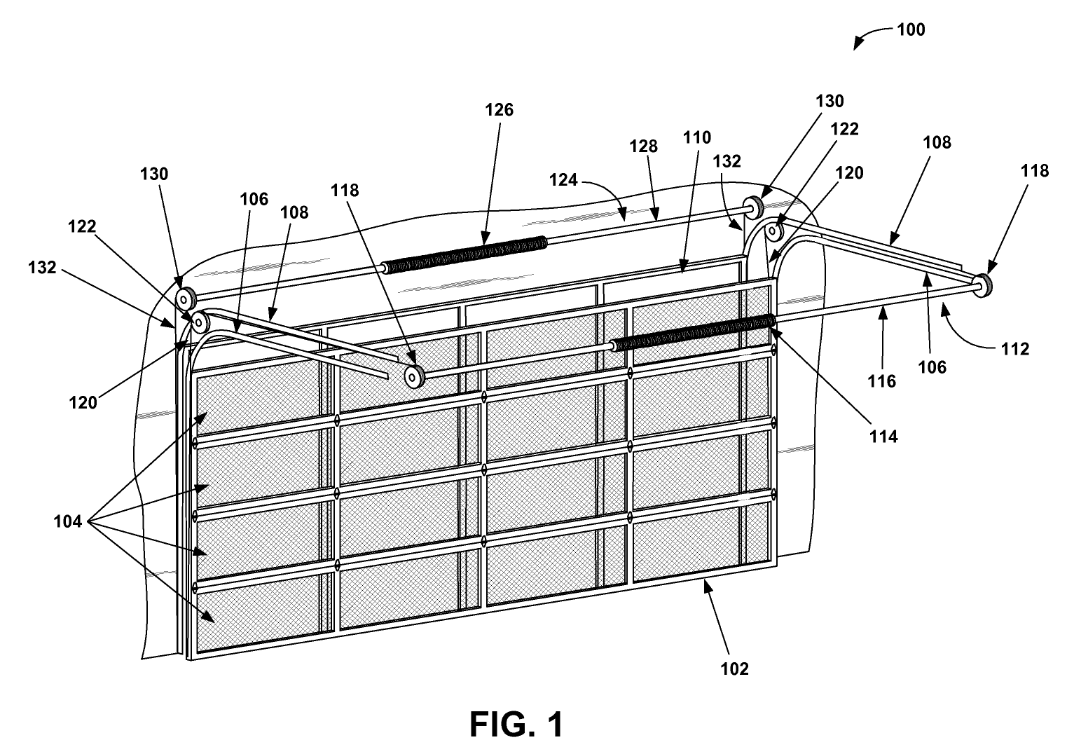

FIG. 1 is a diagram showing an exemplary ventilating security garage door system 100 for use with an existing garage door, in accordance with an embodiment of the present invention. It should be noted that bracketing and other miscellaneous hardware has been removed from FIG. 1 for clarity to better illustrate inventive aspects of the embodiments of the present invention. Bracketing and other miscellaneous hardware placement however will be apparent to those skilled in the art after a careful reading of the present disclosure. As illustrated in FIG. 1, the exemplary ventilating security garage door system 100 includes a ventilating security garage door 102 comprising a plurality of ventilating security garage door panels 104, each connected to at least one other ventilating security garage door panel 104 to form the ventilating security garage door 102.

The ventilating security garage door system 100 further includes two ventilating security garage door rails 106 positioned to the outside and below the existing garage door rails 108. The term outside shall be defined as further away from the center of the interior of the garage than another object. For example, the left ventilating security garage door rail 106 is further away from the center of the interior of the garage than the left garage door rail 108. Similarly, the right ventilating security garage door rail 106 is further away from the center of the interior of the garage than the right garage door rail 108. Thus, the left and right ventilating security garage door rails 106 are defined to be outside the left and right garage door rails 108. The term below shall be defined as at a lower height than another object.

As will be described in greater detail subsequently, the positioning of the ventilating security garage door rails 106 allows the ventilating security garage door 102 to operate independently from the existing garage door 110. To assist in operating the ventilating security garage door 102, embodiments of the present invention also include a rear torsion assembly 112 comprising one or more torsion springs 114 connected to a rear torsion assembly bar 116, which is connected to a plurality of cable drums 118. Each cable drum 118 is connected to a ventilating security garage door cable 120, which itself is connected to the bottom of the ventilating security garage door 102 via a pulley 122. In this manner, the ventilating security garage door cable 120 does not interfere with the existing garage door torsion assembly 124 comprising one or more torsion springs 126 connected to a torsion bar 128, which is connected to a plurality of cable drums 130. Similar to above, each cable drum 130 of the existing garage door torsion assembly 124 is connected to a garage door cable 132, which itself is connected to the bottom of the garage door 110.

It should be noted that although one or more torsion springs 114 can be utilized with the embodiments of the present invention, the use of two torsion springs 114 can reduce stress on the rear torsion assembly 112. For example, in one embodiment, the rear torsion assembly 112 includes two torsion springs 114, a left wound torsion spring and a right wound torsions spring. This arrangement enables the rear torsion assembly 112 to perform without undo stress on the assembly because the left and right torsion springs apply equal and opposing pressure against each other.

As mentioned above, the ventilating security garage door 102 comprises a plurality of ventilating security garage door panels 104. To provide ventilation and allow outside light to illuminate the garage area, each ventilating security garage door panel 104 is formed of a material permeable to light and air, hence allowing ventilation between the sides of the panel. For example, in one embodiment, each ventilating security garage door panel can be formed from perforated steel. The perforated steel can, for example, comprise 20-gage steel with 3/32 perforated holes to allow ventilation. Another material which can form a ventilating security garage door panel is a wire mesh. Although FIG. 1 illustrates an exemplary ventilating security garage door 102 having four ventilating security garage door panels 104, it should be noted that the ventilating security garage door 102 of the embodiments of the present invention can be formed from any number of panels, depending on the needs of a particular implementation.

In one embodiment, the ventilating security garage door 102 is about twelve inches shorter in height than the existing garage door 110 to ensure a proper clearance is provided between the existing garage door 110 and the ventilating security garage door 102 as they transgress the radius of the rails 108 and 106. That is, the measured height of the ventilating security garage door 102 is about twelve inches shorter than the measured height of the existing garage door 110. This can be accomplished, for example, by making each ventilating security garage door panel 104 proportionately shorter than each existing garage door panel to ensure the height of the ventilating security garage door 102 is about twelve inches shorter than the existing garage door 110. For example, when an existing garage door is comprised of four panels and has a height of 84″, each panel of the existing garage door is 21″ in height. To ensure proper clearance, each panel of a four panel ventilating security garage door 104 would be 18″. As a result, the ventilating security garage door 102 would be 72″ in height, which is 12″ shorter than the existing garage door 110. In this manner, the existing garage door 110 and the ventilating security garage door 102 are able to open and close independently of each other.

In one embodiment, each ventilating security garage door panel 104 is longer than each panel of the garage door 110. For example, in one embodiment each ventilating security garage door panel 104 is at least 2″, and preferably about 3″, longer than each panel of the garage door 110. Thus, in this embodiment, each ventilating security garage door panel 104 extends 1½″ further to the left and right of each panel of the garage door 110. For example, when each panel of the garage door 110 is 16′, each ventilating security garage door panel 104 will be 16′ 3″ to allow 1½″ of each ventilating security garage door panel 104 to extend to either side of the garage door 110.

In this manner, embodiments of the present invention allow room for the ventilating security garage door cables 120 to extend down the side of the ventilating security garage door 102 without interfering with the operation of the garage door 110. More specifically, as mentioned above, embodiments of the present invention include a rear torsion assembly 112 comprising one or more torsion springs 114 connected to a rear torsion assembly bar 116, which is connected to a plurality of cable drums 118. Two pulleys 122 are disposed above and to either side of the ventilating security garage door 102. Each ventilating security garage door cable 120 extends from a cable drum 118 to a pulley 122, and then down near a bottom corner of the ventilating security garage door 102.

The rear torsion assembly 112 operates to assist in the operation of the ventilating security garage door 102. For example, when the ventilating security garage door 102 is opened, the torsion springs 114 of the rear torsion assembly function to provide torque on the rear torsion assembly bar 116, which provides torque to each cable drum 118. The torque provided to each cable drum 118 functions wind the ventilating security garage door cables 120 around the cable drums 118. The pulleys 118 change the direction of each ventilating security garage door cable 120, thus allowing each ventilating security garage door cable 120 to providing upward force on the ventilating security garage door 102.

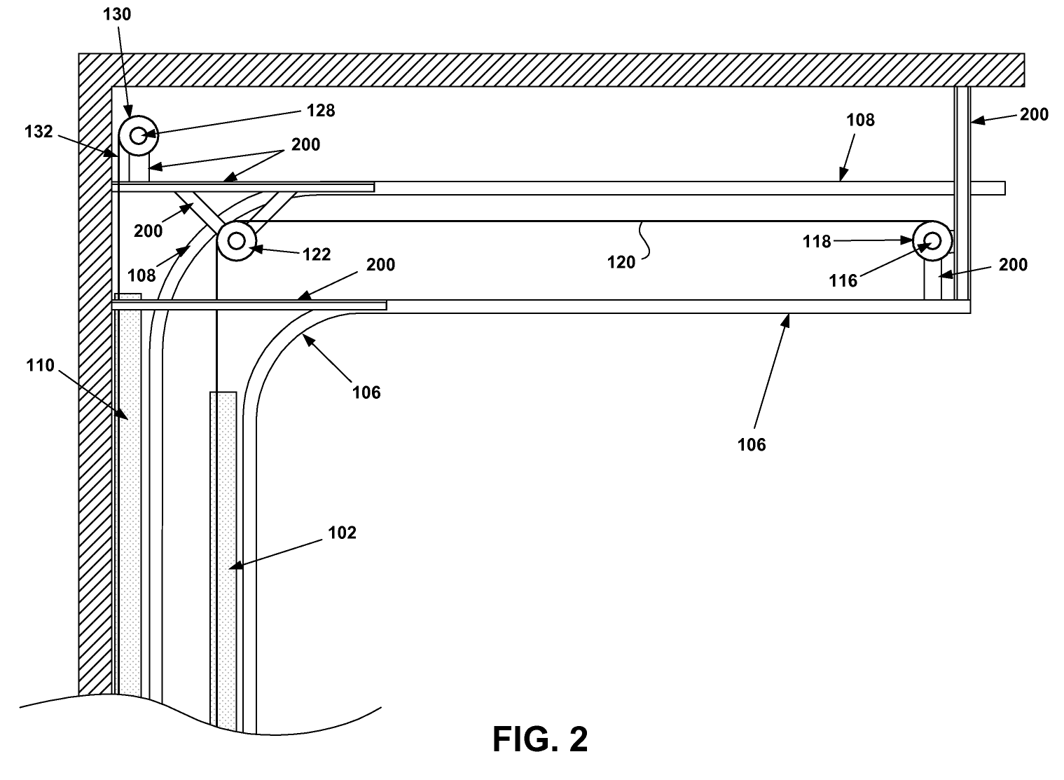

FIG. 2 is a side view of exemplary ventilating security garage door rails 106 and rear torsion assembly 112, in accordance with an embodiment of the present invention. As mentioned previously, the ventilating security garage door system includes ventilating security garage door rails 106 positioned to the outside and below the existing garage door rails 108. The ventilating security garage door rails 106 and the existing garage door rails 108 can be held in position utilizing various brackets 200, the use of which will be apparent to those skilled in the art after a careful reading of the present disclosure.

As mentioned above, the rear torsion assembly functions to provide torque via one or more torsion springs connected to a rear torsion assembly bar 116, which is connected to a plurality of cable drums 118. The exemplary side view of FIG. 2 illustrates one side of the ventilating security garage door system. In particular FIG. 2 illustrates a cable drum 118 connected to a ventilating security garage door cable 120, which itself is connected to the bottom of the ventilating security garage door 102 via a pulley 122. By locating torsion for the ventilating security garage door system to the rear of the unit, the ventilating security garage door cable 120 does not interfere with the existing garage door torsion assembly, illustrated by the torsion bar 128 and cable drum 130. As such, each garage door cable 132 can connect to the bottom of the garage door 110 without interference from the ventilating security garage door system. Moreover, the placement of ventilating security garage door rails 106 in the embodiments of the present invention allows use of the ventilating security garage door system with existing garage doors having traditional chain based garage door openers.

For example, as is well know, a typical traditional chain based garage door opener comprises a unit extending from the header above the garage door 110 to about the middle of a garage space. An arm generally is attached to the top of the garage door 110 and also to a track that runs from the header to a motorized unit. Generally, the arm is driven along the track by a chain, which itself is connected to a sprocket that is driven by the motorized unit. Hence, when the sprocket rotates, the chain drives the arm in particular direction along the track, which in turn lifts or closes the attached garage door 110. By placing the torsion for the ventilating security garage door system to the rear of the unit, the rear torsion assembly of the embodiments of the present invention advantageously does not interfere with the existing garage door operating units, such as the chain based garage door opener discussed above.

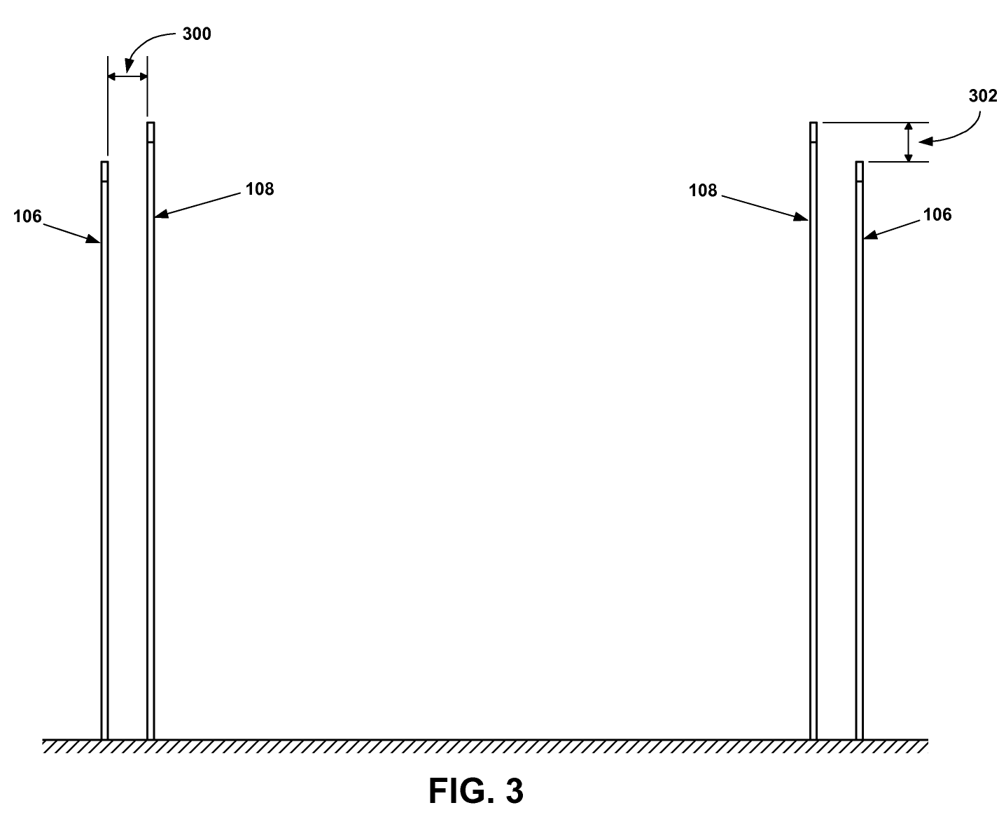

FIG. 3 is a diagram showing a review of the relative rail positions for use with the ventilating security garage door, in accordance with an embodiment of the present invention. As shown in FIG. 3, the ventilating security garage door rails 106 are disposed to the outside of the existing garage door rails 108. For example, as mentioned above, in one embodiment each ventilating security garage rail 106 extends about 1½″ further to the left and right of each panel of the existing garage door rails 108. That is, the distance 300 between each ventilating security garage door rail 106 and existing garage door rail 108 is about 1½″. For example, if the distance between the existing garage door rails is 16′, in this embodiment the distance between the ventilating security garage door rails 106 will be about 16′ 3″, allowing 1½″ between the rails on each side of the system as described above.

Moreover, the distance 302 between the top of the ventilating security garage door rails 106 and the top of the existing garage door rails 108 is designed to allow full operation of the existing garage door and the ventilating security garage door, regardless of the position either door. In this manner, both the existing garage door and the ventilating security garage door can be in the open position simultaneously, in the closed position simultaneously, or in opposites positions simultaneously. Furthermore, the distances 300 and 302 allow the existing garage door and the ventilating security garage door to move simultaneously or individually as needed by the user. As discussed previously, embodiments of the present invention allow room for the ventilating security garage door cables to extend down the side of the ventilating security garage door without interfering with the operation of the existing garage door.

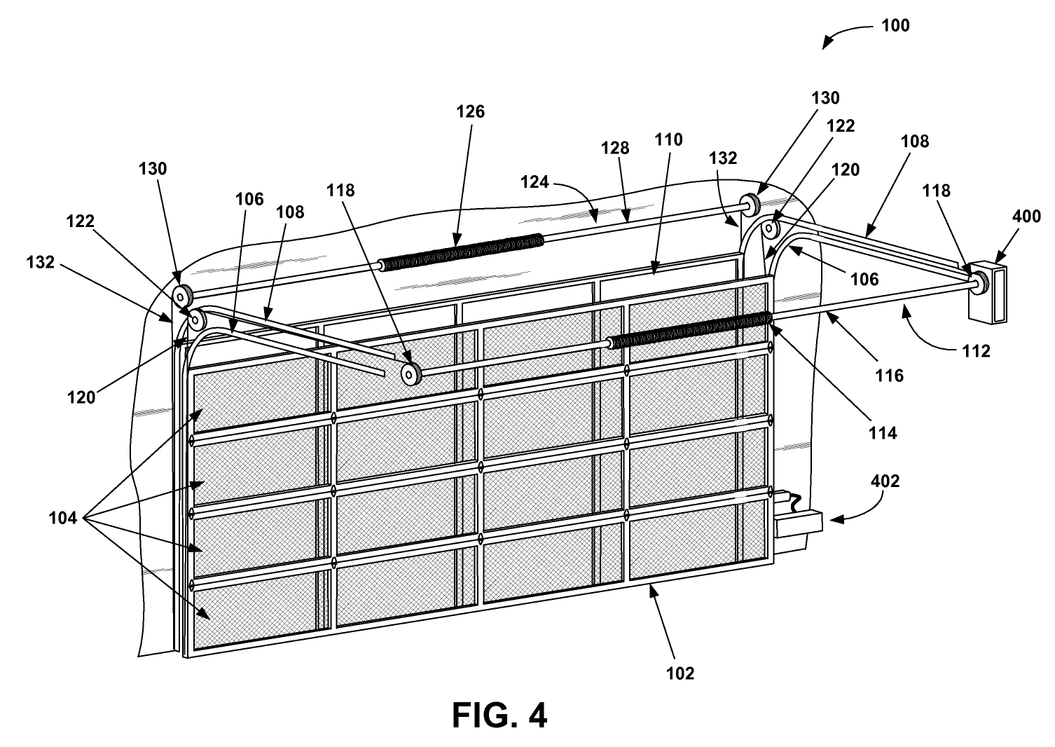

FIG. 4 is a diagram showing an exemplary ventilating security garage door system 100 having automatic operating properties and locking properties, in accordance with an embodiment of the present invention. As with FIG. 1, it should be noted that bracketing and other miscellaneous hardware has been removed from FIG. 4 for clarity to better illustrate inventive aspects of the embodiments of the present invention. Bracketing and other miscellaneous hardware placement however will be apparent to those skilled in the art after a careful reading of the present disclosure. As illustrated in FIG. 4, the exemplary ventilating security garage door system 100 includes a ventilating security garage door 102 comprising a plurality of ventilating security garage door panels 104, each connected to at least one other ventilating security garage door panel 104 to form the ventilating security garage door 102.

In addition, as described above, the ventilating security garage door system 100 further includes two ventilating security garage door rails 106 positioned to the outside and below the existing garage door rails 108. A rear torsion assembly 112 is further included that comprises one or more torsion springs 114 connected to a rear torsion assembly bar 116, which is connected to a plurality of cable drums 118. Each cable drum 118 is connected to a ventilating security garage door cable 120, which itself is connected to the bottom of the ventilating security garage door 102 via a pulley 122. In this manner, the ventilating security garage door cable 120 does not interfere with the existing garage door torsion assembly 124 comprising one or more torsion springs 126 connected to a torsion bar 128, which is connected to a plurality of cable drums 130.

In the embodiment of FIG. 4, a jackshaft garage door opener 400 is connected to the rear torsion assembly 112. In particular, the jackshaft garage door opener 400 is connected to the rear torsion assembly bar 116. In addition, a security lock system 402 can be included that functions to electronically lock the ventilating security garage door 102 when in the closed position. In operation, the jack shaft garage door opener 400 receives commands via radio frequency. When the ventilating security garage door 102 is in the closed position, the jackshaft garage door opener 400 functions to turn the rear torsion assembly bar 116, and thereby turn the cable barrels 118 thus rolling the ventilating security garage door cables 120 upon the cable barrels 118. The ventilating security garage door cables 120 then pull the ventilating security garage door 102 upward via the pulleys 122. The reverse occurs when the ventilating security garage door 102 is in the open position and the jackshaft garage door opener 400 receives a command to close the ventilating security garage door 102.

In one embodiment, each time the user sends a command to open or close the ventilating security garage door 102 the security lock system 402 disengages the lock to allow the ventilating security garage door 102 to move freely along the ventilating security garage door rails 106. Then, when the ventilating security garage door 102 is in the fully closed position, the security lock system 402 engages and locks the ventilating security garage door 102 in the closed position, thereby preventing the ventilating security garage door 102 from being open until a new command is received by the jackshaft garage door opener 400.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A ventilating security garage door system, comprising:
a ventilating security garage door permeable to light and air, wherein the ventilating security garage door is wider than an existing garage door;
a plurality of ventilating security garage door rails whereby the ventilating security garage door can move between an open and closed position, wherein each ventilating security garage door rail is disposed to an outside of an existing garage door rail; and
a rear torsion assembly disposed behind the ventilating security garage door and connected to the ventilating security garage door via cables, whereby the rear torsion assembly provides torque to assist in opening and closing the ventilating security garage door.

2. A ventilating security garage door system as recited in claim 1, wherein the ventilating secure garage door is at least two inches wider than the existing garage door.

3. A ventilating security garage door system as recited in claim 1, wherein the ventilating secure garage door is about three inches wider than the existing garage door.

4. A ventilating security garage door system as recited in claim 1, further comprising a plurality of pulleys positioned to either side and above of the ventilating security garage door, wherein the cables extend from the rear torsion assembly to the ventilating security garage door via the pulleys.

5. A ventilating security garage door system as recited in claim 1, further comprising a jackshaft garage door opener connected to the rear torsion assembly, wherein the jack shaft garage door opener is capable of rotating the rear torsion assembly.

6. A ventilating security garage door system as recited in claim 5, further comprising a security lock system capable of locking the ventilating security garage door when the ventilating security garage door is in a closed position.

7. A ventilating security garage door system as recited in claim 6, wherein the security lock system disengages when the jackshaft garage door opener receives a signal to open or close the ventilating security garage door.

8. A ventilating security garage door system, comprising:
a ventilating security garage door permeable to light and air, wherein the ventilating security garage door is wider than an existing garage door, and wherein the ventilating security garage door is shorter than the existing garage door;
a plurality of ventilating security garage door rails whereby the ventilating security garage door can move between an open and closed position, wherein each ventilating security garage door rail is disposed at least 2 inches to an outside of an existing garage door rail;
a rear torsion assembly disposed behind the ventilating security garage door and connected to the ventilating security garage door via cables, the rear torsion assembly having a rear torsion assembly bar connected to at least one torsion spring, whereby the rear torsion assembly provides torque to assist in opening and closing the ventilating security garage door; and
a jackshaft garage door opener connected to the rear torsion assembly bar, wherein the jack shaft garage door opener is capable of rotating the rear torsion assembly bar.

9. A ventilating security garage door system as recited in claim 8, wherein the ventilating secure garage door is about three inches wider than the existing garage door.

10. A ventilating security garage door system as recited in claim 8, further comprising a plurality of pulleys positioned to either side and above of the ventilating security garage door, wherein the cables extend from the rear torsion assembly to the ventilating security garage door via the pulleys, and wherein the cables extend between the ventilating security garage door rails and the existing garage door rails.

11. A ventilating security garage door system as recited in claim 8, further comprising a security lock system capable of locking the ventilating security garage door when the ventilating security garage door is in a closed position.

12. A ventilating security garage door system as recited in claim 11, wherein the security lock system disengages when the jackshaft garage door opener receives a signal to open or close the ventilating security garage door.

13. A ventilating security garage door system as recited in claim 12, wherein the security lock system is disposed to one side of the ventilating security garage door, and wherein the security lock system is positioned nearer to a bottom edge of the ventilating security garage door than to a top edge of the ventilating security garage door.

14. A ventilating security garage door system as recited in claim 8, wherein the cables connected to the ventilating security garage door nearer to a bottom edge of the ventilating security garage door than to a top edge of the ventilating security garage door.

15. A ventilating security garage door system as recited in claim 8, wherein the ventilating security garage door comprises a plurality of panels, each panel being manufactured from perforated steel.

16. A ventilating security garage door system as recited in claim 15, wherein in each panel is about three inches longer than a panel of the existing garage door.
